(19) United States
(12) Patent Application Publication
(10) Pub. No.: US 2006/0076721 A1
(43) Pub. Date: Apr. 13, 2006

(54) Antivibration device and a vehicle including such a device

(75) Inventors: Bernard Bouhier, Noyers Sur Cher (FR); Pascal Carobolante, Saint Hilaire De Court (FR)

Correspondence Address: Brent E. Matthias;MILLER MATTHIAS & HULL, Suite 2350, One North Franklin Street, Chicago, IL, 60606, US

(73) Assignee: Hutchinson, Paris (FR)

(21) Appl. No.: 11/247,985

(22) Filed: Oct. 11, 2005

(30) Foreign Application Priority Data
Oct. 11, 2004 (FR) 0410704

(51) Int. Cl. F16F 7/00

(52) U.S. Cl. 267/141.2

(57) ABSTRACT

An antivibration device comprising an inner strength member, an outer strength member, and an elastomer body interconnecting the inner and outer strength members, the elastomer body defining at least a first liquid-filled chamber, the device being characterized in that the first chamber is leaktight and disposed between the inner strength member and the outer strength member.

### BACKGROUND OF THE INVENTION

The present invention relates to antivibration devices.

More particularly, the invention relates to an antivibration device comprising an inner strength member extending along a longitudinal axis, an annular outer strength member surrounding the inner strength member, a first intermediate strength member disposed between the outer strength member and the inner strength member, and an elastomer body interconnecting the inner and outer strength members, the elastomer body defining at least a first liquid-filled chamber.

### TECHNICAL ART

Document FR 2 655 112 describes an example of such a device comprising two chambers in which a constricted passage enables the two chambers to communicate with each other so as to obtain hydraulic damping due to the fluid passing from one chamber to the other chamber.

Nevertheless, with that type of device, it is very difficult to obtain high stiffness ratios between the various axes, while nevertheless conserving the ability for the strength members to move relative to one another along one axis.

A particular object of the present invention is to mitigate those drawbacks.

### DISCLOSURE OF THE INVENTION

To this end, according to the invention, an antivibration device of the kind in question is characterized in that the first chamber is leaktight and is disposed between the inner strength member and the outer strength member in such a manner:
as to be subjected to compression stress substantially without change in volume when the inner and outer strength members move relative to each other in a radial direction perpendicular to said longitudinal axis; and
as to offer less resistance when the inner and outer strength members move in an axial direction distinct from the first direction,

By means of these dispositions, the antivibration device presents a high stiffness ratio between two directions.

In various embodiments of the device of the invention, recourse may optionally be had to one or more of the following dispositions:
the first chamber is disposed so as to deform substantially without increasing the pressure of the liquid when the inner and outer strength members move relative to each other in the second direction;
the first intermediate strength member is disposed adjacent to the outer strength member;
the first chamber is disposed radially between the inner and outer strength members;
the device includes two liquid-filled first chambers that are independent, i.e. they are leaktight and do not communicate with one another;
the two first chambers are diametrically opposite and disposed radially between the inner strength member and the outer strength member;
the device includes two second liquid-filled chambers that are independent, being disposed diametrically opposite each other between the inner strength member and the outer strength member, and being aligned perpendicularly to the two first chambers;
the device includes at least one second intermediate strength member surrounding the inner strength member and embedded in the elastomer body;
the device further includes two additional liquid-filled chambers disposed axially on either side of said first chamber and interconnected by at least one duct;
the inner strength member and the outer strength member present portions that extend outwards in a radial direction and the first chamber is disposed axially between said portions; and
the elastomer body further includes a recess extending longitudinally between the outer strength member and the inner strength member.

Other characteristics and advantages of the present invention are explained on reading the description below with reference to the accompanying drawings, in which:

### BRIEF DESCRIPTION OF THE DRAWINGS

FIG. 1 is a longitudinal section view of an antivibration device in a first embodiment;

FIG. 2 is a cross-section view of the device shown in FIG. 1;

FIG. 3 is a cross-section view of an antivibration device in a variant embodiment;

FIG. 4 is a perspective view in section on two perpendicular planes showing the FIG. 1 device in another variant; and

FIG. 5 is a longitudinal section view of a device in a second embodiment.

### DETAILED DESCRIPTION

The antivibration devices of the above-described type are used in a variety of applications, in particular for damping vibration between two elements of a vehicle, e.g. between the body and its suspensions. For this purpose, such devices comprise an inner strength member which can be connected to an element of a suspension, and an outer strength member which can be connected to an element of the bodywork. Vibration is then damped by an elastomer body interposed between the inner strength member and the outer strength member. The device serves to damp vibration coming from the wheels of the vehicle, and traveling towards the bodywork, and thus serves to provide the user with improved comfort.

As shown in FIG. 1, a diagrammatic example of an antivibration device 10 in accordance with the invention comprises two strength members: an inner strength member 12 and an outer strength member 14, both of which are cylindrical. The inner and outer strength members 12 and 14 are coaxial about a longitudinal axis Z.

The device further comprises an elastomer body 16 disposed between the inner and outer strength members 12 and 14. The device also includes a first intermediate strength member 18, or “window” strength member, coated in an elastomer body 16 and disposed adjacent to the outer strength member 14. The first intermediate strength member 18 co-operates with the outer strength member 14 to ensure that the device is leaktight.

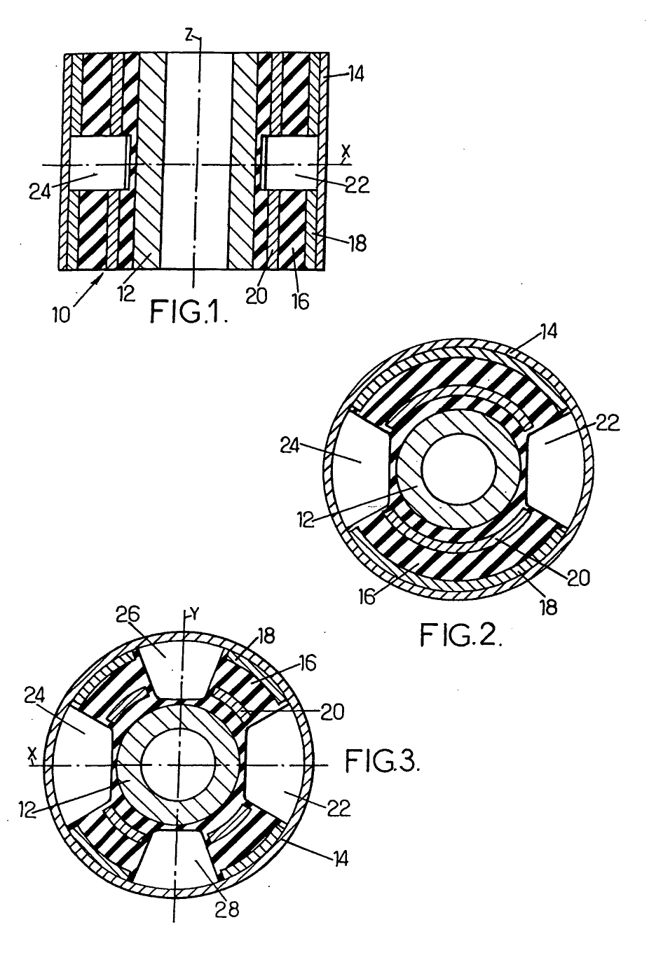

As shown in FIG. 1, the device includes a second intermediate strength member 20 interposed between the inner strength member 12 and the first intermediate strength member 18, within the elastomer body 16. The intermediate strength members are cylindrical and coaxial about the longitudinal axis Z. The portions of the intermediate strength members 18 and 20 that can be seen in FIG. 2 are in the form of circular arcs centered on the longitudinal axis Z and surrounding the inner strength member 12.

During manufacture of the device, the elastomer body 16 is molded so as to coat the intermediate strength members 18 and 20. It is bonded to the intermediate strength members 18 and 20 and to the inner strength member suing methods that are known to the person skilled in the art. The outer strength member 14 is engaged on the molded element and is crimped thereto.

The elastomer body 16 also defines two chambers 22 and 24 that are filled with liquid, e.g. glycol or silicone. The chambers 22 and 24 are disposed radially between the inner strength member 12 and the outer strength member 14, and they pass via a midplane that extends perpendicularly to the longitudinal axis Z. The chambers 22 and 24 are diametrically opposite and present an axis of symmetry constituted by the longitudinal axis Z.

Each of the intermediate strength members 18 and 20 presents two openings or windows corresponding to the sections of the chambers 22 and 24.

In the cross-section of FIG. 2, the chambers 22 and 24 present sections that are substantially trapezoidal, and they extend radially along the X axis inside the device 10. They are defined in part by the outer strength member 14 and by the elastomer body 16.

The chambers 22 and 24 are leaktight, i.e. they are independent and they do not communicate with each other.

Thus, when the device 10 is stressed in the radial direction X, the chambers 22 and 24 are subjected to compression force without changing in volume since they are filled with liquid. The stiffness of the device 10 along the radial axis X is therefore relatively high, since the elastomer body 16 deforms little in compression, and the chambers 22 and 24 being filled with incompressible liquid contributes to increasing stiffness along this axis.

The symmetrical disposition of the chambers 22 and 24 about the longitudinal axis Z makes it possible to obtain substantially identical stiffnesses when the device is stressed in either direction along the radial axis X.

When the device is stressed along the longitudinal axis Z, one of the inner or outer strength members 12 or 14 is urged along said longitudinal axis Z, and the elastomer body 16 then deforms in that direction. The elastomer body 16 presents deformation characteristics that are greater in shear than in compression, so it is easier to deform along the longitudinal direction Z. The chambers 22 and 24 offer less resistance along the longitudinal direction Z. The chambers are disposed so as to deform substantially without increasing the pressure of the liquid when the inner and outer strength members 12 and 14 move relative to each other along the longitudinal direction Z. Pressure therefore increases less in the chambers 22 and 24 during displacement of either one of the inner and outer strength members along the longitudinal axis Z.

The ratio between stiffness along the radial axis X and along the longitudinal axis Z is then particularly high, and this is achieved without modifying the hardness of the mixture constituting the elastomer body 16, or indeed without modifying the dimensions and the thickness of the elastomer body 16. In prior art devices, stiffness ratios are obtained that are equivalent to those of the device of the invention, but by using thicknesses for the elastomer body 16 that do not permit significant displacements between the outer and inner strength members along the longitudinal axis, or along the radial axis. In particular if the thickness of the elastomer body 16 is decreased along the radial axis, radial stiffness is increased. Axial stiffness is also increased, but more slowly than is radial stiffness. The ratio of radial stiffness over axial stiffness is thus increased, but the resulting device does not allow for significant deformation of the elastomer body 16 along the longitudinal axis Z, and therefore does not allow for large amounts of displacement between the inner strength member 12 and the outer strength member 14.

In a variant of the invention, as shown in FIG. 3, the device 10 of the invention includes two second chambers 26 and 28 disposed radially between the inner and outer strength members 12 and 14 along an axis Y perpendicular to the axis X. This disposition makes it possible to ensure that stiffnesses along the two radial directions X and Y are made symmetrical.

Under such circumstances, the stiffness ratio between either of the two radial stiffnesses and the longitudinal stiffness is even greater, since the elastomer body 16 presents greater ability to deform in shear, since a portion of the elastomer body 16 is replaced by the two second chambers.

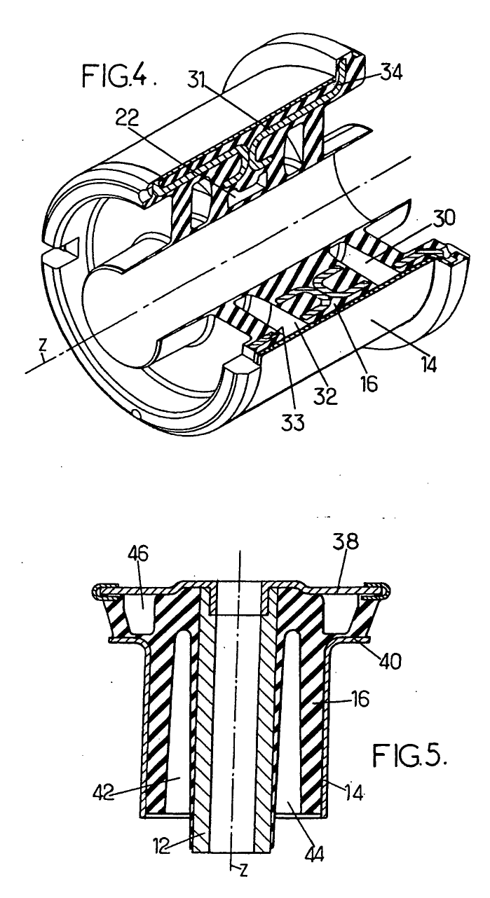

A variant of the first embodiment of the device is shown in FIG. 4. In this figure, elements that are identical to those of the preceding figures are given the same references as in the preceding figures.

The device shown in FIG. 4 has two radial chambers, only one of which, 22, is shown. The radial chambers 22 are not in communication and they are disposed in a common midplane perpendicular to the longitudinal axis Z, as described above. The device further comprises two additional chambers 30 and 32 that are axial and disposed axially on either side of the radial chambers 22. In FIG. 4, the axial chambers 30 and 32 are disposed towards the longitudinal ends of the device 10. The axial chambers 30 and 32 extend in two distal planes parallel to the midplane perpendicular to the longitudinal axis Z, and present a shape that is substantially circular.

Each axial chamber 30, 32 opens out to the surface of the elastomer body 16 via two partially-circular openings, i.e. openings in the form of circular arcs and disposed in diametrically-opposite positions. The chambers 30 and 32 are interconnected by at least one duct (not shown in FIG. 4).

The device further comprises an intermediate strength member 34 made by assembling together two metal elements of semicylindrical shape and surrounding the inner strength member 12. These elements are formed by stamping and then they are assembled together, e.g. by welding. They are of a length that is slightly greater than the length of the outer strength member 14, and they present a curved end 34. Thus, the outer strength member 14 is engaged onto the window strength member 34 and is then crimped and blocked in position with a layer of elastomer 16 being interposed between them. The curved end 34 limits the longitudinal displacement of the window strength member 18 relative to the outer strength member 14, and serves to make the device leaktight.

Each of the elements present two windows or openings 33, these openings defining the sections of the additional chambers 30 and 32 in the axial set.

The device as described above presents a ratio of radial stiffness over longitudinal stiffness that is high. The liquid-filled radial chambers that are not in communication contribute to increasing radial stiffness, whereas the additional axial chambers opening out into the surface of the elastomer body 16 contributes to decreasing the axial stiffness of the device.

The layer of the elastomer body 16 situated between the radial chambers 22 and the axial chambers 30 and 32 positioned at the longitudinal ends is more easily deformable, in particular in shear or in bending, since it is of smaller thickness. The device can then be used for vehicle elements subjected to stress essentially along the longitudinal axis Z.

In another embodiment shown in FIG. 5, the antivibration device comprises an inner strength member 12 and an outer strength member 14 that are annular and coaxial, each having a portion 38, 40 extending radially outwards. These portions are disposed facing each other.

An elastomer body 16 is placed between the strength members 12 and 14 and is bonded to the inner strength member 12. The elastomer body 16 also extends between the two radial portions 38 and 40 of the inner strength member 12 and of the outer strength member 14.

The elastomer body 16 has two openings 42, 44 that are symmetrical and a chamber 46 that is circular. The openings extend substantially parallel to the longitudinal axis Z between the outer strength member 14 and the inner strength member 12, and they extend substantially circumferentially. The chamber 46 extends axially between each radially-extending portion 38, 40 of the inner strength member 12 and of the outer strength member 14. The chamber 46 is filled with liquid, and is completely leaktight.

Thus, when the inner or outer strength member 12 or 14 is stressed along the longitudinal axis Z, the elastomer body 16 disposed between the portions 38 and 40 of the inner and outer strength members 12 and 14 deforms little since it has little ability to deform in compression without varying the volume of the chamber 46. Stiffness along the longitudinal direction Z is therefore high.

The elastomer body 16 situated between the chambers 42, 44, and 46 of the first and second sets deforms in bending when stress in a radial direction. The portion of the elastomer body that is then subjected to strain is the portion situated between chambers of different sets.

Thus, the ratio of axial stiffness over radial stiffness is very high, making it possible to obtain a device suitable for being placed between two elements that move essentially in a transverse direction perpendicular to the longitudinal axis Z in order to absorb vibration in this direction.

In the device, the inner strength member (12) and the outer strength member (14) present portions (38, 40) extending radially outwards, and the first chamber (46) is disposed axially between the portions (38, 40). The elastomer body (16) also includes at least one opening (42) extending longitudinally between the outer strength member (14) and the inner strength member (12).

In a variant of the invention, the two openings 42, 44 may be replaced by a circular chamber in order to obtain smaller stiffness in the radial direction.

1. An antivibration device comprising an inner strength member extending along a longitudinal axis, an annular outer strength member surrounding the inner strength member, a first intermediate strength member disposed between the outer strength member and the inner strength member, and an elastomer body interconnecting the inner and outer strength members, the elastomer body defining at least a first liquid-filled chamber,
wherein the first chamber is leaktight and is disposed between the inner strength member and the outer strength member in such a manner:
as to be subjected to compression stress substantially without change in volume when the inner and outer strength members move relative to each other in a radial direction perpendicular to said longitudinal axis; and
as to offer less resistance when the inner and outer strength members move in an axial direction distinct from the first direction, and in that the device further includes two additional liquid-filled chambers disposed axially on either side of said first chamber and interconnected by at least one duct.

2. A device according to claim 1, wherein the first chamber is disposed so as to deform substantially without increasing the pressure of the liquid when the inner and outer strength members move relative to each other in the second direction.

3. A device according to claim 1, wherein the first intermediate strength member is disposed adjacent to the outer strength member.

4. A device according to claim 1, wherein the first chamber is disposed radially between the inner and outer strength members.

5. A device according to claim 1, including two liquid-filled first chambers that are independent.

6. An antivibration device according to claim 5, wherein the two first chambers are diametrically opposite and disposed radially between the inner strength member and the outer strength member.

7. A device according to claim 6, further including two second liquid-filled chambers that are independent, being disposed diametrically opposite each other between the inner strength member and the outer strength member, and being aligned perpendicularly to the two first chambers.

8. A device according to claim 1, including at least one second intermediate strength member surrounding the inner strength member and embedded in the elastomer body.

9. A vehicle including a device according to claim 1.
